(19) United States
(12) Patent Application Publication
(10) Pub. No.: US 2018/0188373 A1
(43) Pub. Date: Jul. 5, 2018

(54) SCANNING-TYPE DISTANCE MEASURING APPARATUS

(71) Applicants: Motomu Yokota, Aichi (JP); Hoshibumi Ichiyanagi, Aichi (JP)

(72) Inventors: Motomu Yokota, Aichi (JP); Hoshibumi Ichiyanagi, Aichi (JP)

(73) Assignee: OMRON AUTOMOTIVE ELECTRONICS CO., LTD., Aichi (JP)

(21) Appl. No.: 15/862,386

(22) Filed: Jan. 4, 2018

(30) Foreign Application Priority Data
Jan. 4, 2017 (JP) 2017-000160

(51) Int. Cl. G01S 17/93; G01S 17/42; G01S 7/483; G01S 7/292

(52) U.S. Cl. CPC G01S 17/93; G01S 7/2926; G01S 7/483; G01S 17/42

(57) ABSTRACT

A scanning-type distance measuring apparatus includes: a light projector projecting laser beams at predetermined intervals; a light receiver including light receiving elements, receiving a reflected beam of a laser beam that the light projector projects, and outputting a light reception intensity signal of the reflected beam; a scanning operation unit projecting a laser beam projected by the light projector to perform scanning; an integrator integrating, for each light receiving element, time-series light reception intensity signals output by the light receiver when the light receiver receives reflected beams corresponding to the laser beams projected at the predetermined intervals; and a distance calculator calculating a distance to an object for each light receiving element, based on integration that the integrator performs. The integrator integrates one light reception intensity signal output from one light receiving element and integrates one light reception intensity signal output from another light receiving element.

### CROSS-REFERENCE TO RELATED APPLICATION

This application is based on Japanese Patent Application No. 2017-000160 filed with the Japan Patent Office on Jan. 4, 2017, the entire contents of which are incorporated herein by reference.

### FIELD

The disclosure relates to a scanning-type distance measuring apparatus, and more particularly to a scanning-type distance measuring apparatus that measures a distance by projecting a laser beam and receiving the reflected laser beam.

### BACKGROUND

Conventionally, there has been known techniques of measuring a distance or detecting an obstacle by projecting a laser beam to perform scanning, and receiving the reflected laser beam. For example, JP 2004-177350 A discloses a vehicle radar apparatus in which detection sensitivity of a reflected wave reflected by a reflecting object is improved. This vehicle radar apparatus integrates a predetermined number of light reception signals output based on a predetermined number of emitted laser beams adjacent to each other, and outputs an integrated signal. By integrating the predetermined number of light reception signals, a light reception signal component corresponding to the reflected wave from the reflecting object is amplified. Therefore, detection sensitivity of the reflected wave from the reflecting object can be improved. At that time, a plurality of ranges of light reception signals to be integrated may be set while shifting the range of the received signals to be integrated by an amount of one light reception signal each time. Thus, it is possible to minimize lowering of angular resolution due to the integrated signal.

In addition, JP 2005-300233 A discloses an integration-type vehicle radar apparatus in which the calculation processing load of integration processing of light reception signals is reduced while lowering of detection performance such as shortening of a detectable distance is prevented. This vehicle radar apparatus performs integration processing of integrating a plurality of light reception signals corresponding to a plurality of emitted laser beams adjacent to each other. Thus, detection sensitivity of a reflecting object can be improved. However, in this integration processing, since digital data at an identical sampling timing is integrated in each range of light reception signals targeted for integration, the calculation amount increases as the number of sampling times increases. Therefore, a delay block adjusts delay time of a sampling start timing of the light reception signal with reference to a laser beam irradiation timing. Therefore, even if the number of sampling times is made smaller than the number of sampling times required to cover the entire detection distance in order to reduce a calculation load, a reflecting object can be detected over the entire detection distance described above by appropriately changing the delay time.

In addition, JP 05-203738 A discloses an obstacle detection apparatus for a vehicle which appropriately detects and evaluates an obstacle in a case where there is a plurality of obstacles in a detection area and in a case where there is a moving obstacle, irrespective of a change in a traveling state of a vehicle and a behavior of the obstacle. This obstacle detection apparatus calculates lateral acceleration, a tire slip angle, a tire slip ratio, longitudinal acceleration, a steering angle, a yaw rate, or the like from vehicle speed and the steering angle. For example, in a case where the yaw rate is greater than a predetermined value, the obstacle detection apparatus determines that the vehicle driving state is unstable, and sets an overlapping width where areas to be scanned by sector beams overlap with each other to a great value. Otherwise, the obstacle detection apparatus sets the overlapping width to a normal value and sets a divergence angle of a small area.

In the techniques described above, in order to reduce the influence of noise on a received reflected beam and to amplify a reception intensity signal corresponding to the reflected beam from an object, signals output from a light receiving element are integrated a plurality of times. It is easier to integrate reception intensity signals corresponding to reflected beams from an identical obstacle if an identical light receiving element from among a plurality of light receiving elements continuously outputs reception intensity signals correspondingly to a plurality of emitted laser beams adjacent to each other. Therefore, a distance is usually measured based on light reception intensity signals continuously output from an identical light receiving element a plurality of times. However, in the case of a scanning-type apparatus, an area from which a light receiving element cannot receive a reflected beam is generated, the area corresponding to a scan angle of a laser beam which moves while the apparatus acquires an output signal from another light receiving element. The area is so-called an undetected area for the light receiving element.

In view of the above, the disclosure provides a scanning-type distance measuring apparatus that enables reduction in the undetected area for each light receiving element and makes detection omission less likely to occur.

### SUMMARY

In order to solve the above-described problem, the disclosure provides a scanning-type distance measuring apparatus including: a light projector configured to project laser beams at predetermined intervals; a light receiver including a plurality of light receiving elements and configured to receive a reflected beam of a laser beam that the light projector projects and to output a light reception intensity signal of the reflected beam; a scanning operation unit configured to at least project a laser beam projected by the light projector to perform scanning; an integrator configured to integrate, for each light receiving element, time-series light reception intensity signals output by the light receiver when the light receiver receives reflected beams corresponding to the laser beams projected at the predetermined intervals; and a distance calculator configured to calculate a distance to an object for each light receiving element, based on integration that the integrator performs. The integrator integrates one light reception intensity signal output from one light receiving element and then integrates one light reception intensity signal output from another light receiving element.

The scanning-type distance measuring apparatus integrates a light reception intensity signal output from one light receiving element and then integrates a light reception intensity signal output from another light receiving element. Thus, an identical light receiving element does not continuously output light reception intensity signals, resulting in reduction in time taken to acquire output signals from another light receiving element. Therefore, it is possible to provide a scanning-type distance measuring apparatus that enables reduction in the undetected area in each output from each light receiving element and makes detection omission less likely to occur.

The scanning-type distance measuring apparatus may further include a multiplexer configured to select an output from one light receiving element from among outputs from the plurality of light receiving elements. The multiplexer may select an output from one light receiving element and then selects an output from another light receiving element.

According to the above scanning-type distance measuring apparatus, it is possible to easily switch an output from one light receiving element to an output from another light receiving element.

Furthermore, the light projector may include a light projecting element array including a plurality of light projecting elements arranged in a row. The light receiver may include a light receiving element array including the plurality of light receiving elements arranged in a row in a direction identical to a direction in which the plurality of light projecting elements of the light projecting element array is arranged. The scanning operation unit may cause the light projector and the light receiver to perform scanning in a direction orthogonal to the direction in which the plurality of light projecting elements is arranged in the light projecting element array and orthogonal to the direction in which the plurality of light receiving elements is arranged in the light receiving element array. The multiplexer may select one light receiving element from the light receiving element array. The light projector may cause the light projecting element to project a laser beam which projects a laser beam reflected and received by the light receiving element selected by the multiplexer.

Thus, the one-dimensional light projector and the one-dimensional light receiver can measure a distance in a two-dimensional area.

The disclosure can provide a scanning-type distance measuring apparatus that enables reduction in the undetected area for each light receiving element and makes detection omission less likely to occur.

### BRIEF DESCRIPTION OF THE DRAWINGS

FIGS. 1A, 1B, 1C, and 1D are a top view, a front view, a perspective view, and a side view of a scanning-type distance measuring apparatus according to a first embodiment of the disclosure, respectively;

FIGS. 2A, 2B, 2C, and 2D are a top view, a front view, a perspective view seen from an identical direction as in FIG. 1C, and a bottom view of the scanning-type distance measuring apparatus according to the first embodiment of the disclosure, respectively, in a case where a cover and the like are removed;

FIG. 3 is a block diagram of the scanning-type distance measuring apparatus according to the first embodiment of the disclosure;

FIGS. 4A and 4B are a schematic side view and a schematic front view of the scanning-type distance measuring apparatus according to the first embodiment of the disclosure, respectively;

FIGS. 5A and 5B are a schematic view of a laser diode module and a schematic view of a photodiode module of the scanning-type distance measuring apparatus according to the first embodiment of the disclosure, respectively;

FIG. 6 is a circuit diagram of a light projector of the scanning-type distance measuring apparatus according to the first embodiment of the disclosure;

FIG. 7 is a circuit diagram of a light receiver of the scanning-type distance measuring apparatus according to the first embodiment of the disclosure;

FIG. 8 is an explanatory view illustrating a case where the scanning-type distance measuring apparatuses according to the first embodiment of the disclosure are installed in a vehicle;

FIG. 9 is an explanatory view illustrating scanning operation of the scanning-type distance measuring apparatus according to the first embodiment of the disclosure;

FIG. 10 is an explanatory view illustrating a light receiving and projecting method of the scanning-type distance measuring apparatus according to the first embodiment of the disclosure;

FIG. 11 is an explanatory view for explaining light projection and reception timings in the scanning-type distance measuring apparatus according to the first embodiment of the disclosure;

FIG. 12 is an explanatory view for explaining undetected areas of the scanning-type distance measuring apparatus according to the first embodiment of the disclosure;

FIG. 13 is an explanatory view for explaining an integrating method of an integrator of the scanning-type distance measuring apparatus according to the first embodiment of the disclosure;

FIG. 14 is a block diagram of a scanning-type distance measuring apparatus according to a second embodiment of the disclosure;

FIGS. 15A and 15B are a schematic view of laser diode modules and a schematic view of a photodiode module of the scanning-type distance measuring apparatus according to the second embodiment of the disclosure, respectively;

FIG. 16 is a circuit diagram of a light projector of the scanning-type distance measuring apparatus according to the second embodiment of the disclosure;

FIG. 17 is a circuit diagram of a light receiver of the scanning-type distance measuring apparatus according to the second embodiment of the disclosure;

FIG. 18 is an explanatory view illustrating a light receiving and projecting method of the scanning-type distance measuring apparatus according to the second embodiment of the disclosure;

FIG. 19 is an explanatory view for explaining light projection and reception timings in the scanning-type distance measuring apparatus according to the second embodiment of the disclosure; and

FIG. 20 is an explanatory view for explaining undetected areas of the scanning-type distance measuring apparatus according to the second embodiment of the disclosure.

### DETAILED DESCRIPTION

Each embodiment will be described below with reference to the drawings. In the drawings, the identical or equivalent component is designated by the identical numeral. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention.

### First Embodiment

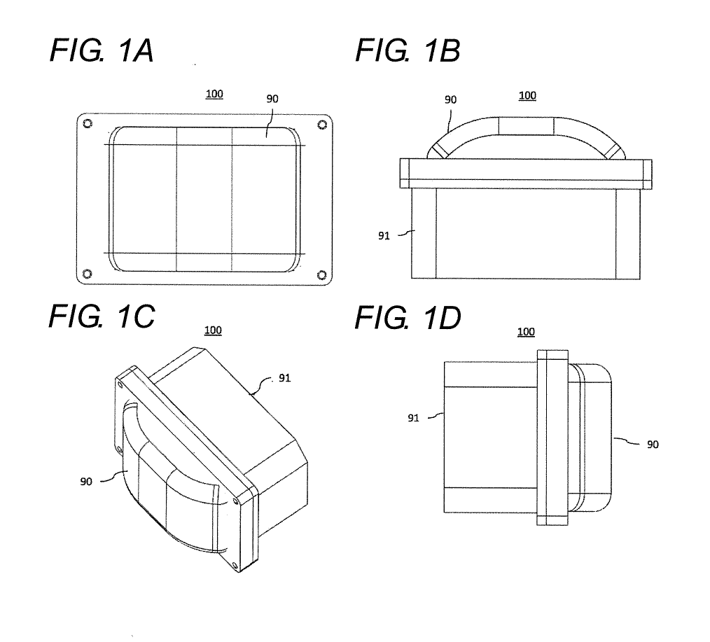

A scanning-type distance measuring apparatus 100 according to one or more embodiments of the disclosure will be described with reference to FIGS. 1A to 13. The scanning-type distance measuring apparatus 100 is installed on a moving body and detects the distance to an object OBJ. Note that in this specification, a vehicle (automobile, train, motorcycle, or the like) moving on the ground will be described as an example of the moving body. However, the moving body may be a ship moving on water or a flight vehicle moving in the air.

The scanning-type distance measuring apparatus 100 measures the distance to and the direction of a measurement target, based on the time difference between laser light emission and reception of the reflected laser beam and the projection direction of the emitted laser beam. A laser beam is excellent in directivity and convergence. A scanning direction is a direction in which a laser beam is projected to perform scanning. In the embodiment, as will be described later, a light projection direction and a light reception direction are changed one dimensionally. The light projection direction and the light reception direction are vertical to the direction in which laser diodes emitting light are arranged one-dimensionally in a laser diode array and the direction in which photodiodes receiving light are arranged one-dimensionally in a photodiode array. Therefore, a plane is scanned (two-dimensional scanning is performed) in scanning performed once.

As illustrated in FIGS. 1A to 1D, the scanning-type distance measuring apparatus 100 includes a laser radar cover 90 which is arcuate in front view, and a laser radar housing 91 which is substantially rectangular parallelepiped and includes constituents such as the laser diodes and the photodiodes to be described later inside. The laser radar cover 90 is made of a material that transmits a laser beam and the reflected laser beam (electromagnetic wave), and allows a laser beam emitted from the laser diode to be projected on the object OBJ and the reflected laser beam from the object OBJ to be received.

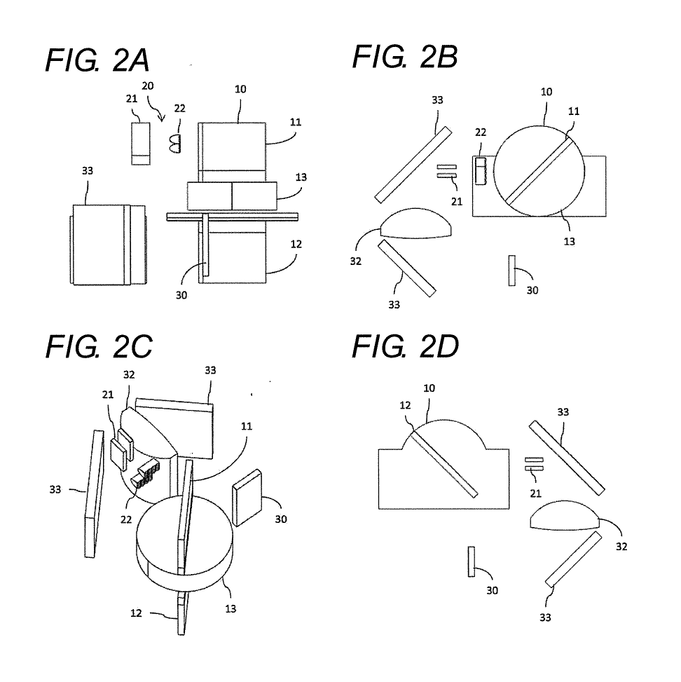

FIGS. 2A to 2D are views illustrating only main constituents included inside the laser radar housing 91 by removing the laser radar cover 90 and the laser radar housing 91. FIG. 2A is a top view, as viewed from the laser radar cover 90 which is arcuate. The scanning-type distance measuring apparatus 100 includes a laser diode module (LD module) 20 that emits a laser beam, a photodiode module (PD module) 30 that receives the reflected laser beam, and a rotary mirror 10 that projects the laser beam emitted by the laser diode module 20 and guides the reflected laser beam to the photodiode module 30 while being rotated by a motor 13.

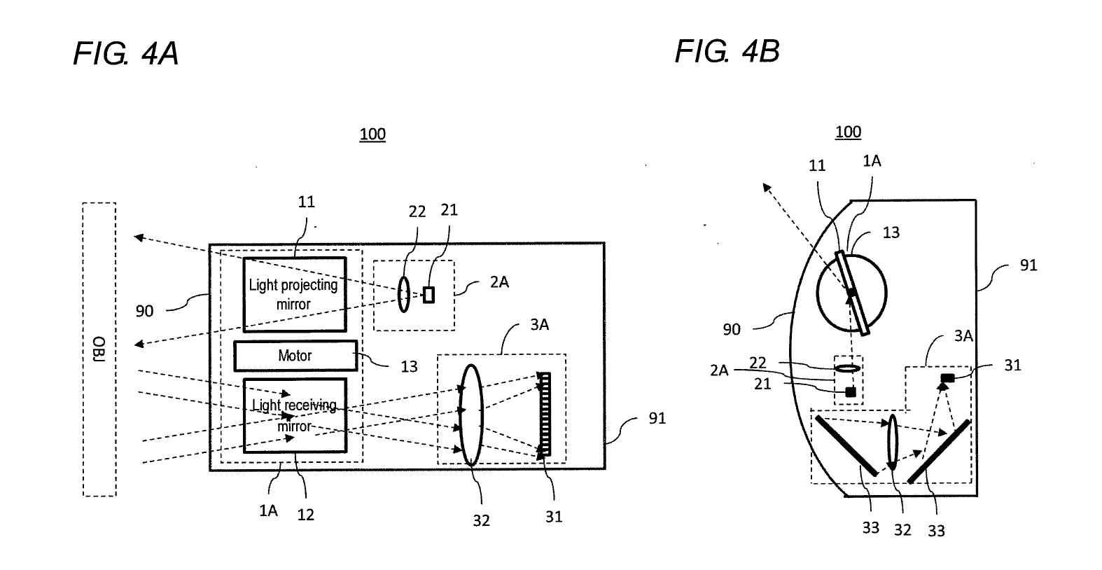

The laser diode module 20 includes a laser diode array 21 that actually emits a laser beam, and a condenser lens 22 that condenses the expanded laser beam and narrows the divergence angle of the laser beam. As illustrated in FIGS. 4A and 4B, the photodiode module 30 includes a photodiode array 31 that actually receives the reflected laser beam and converts the reflected laser beam into an electric signal, two fixed mirrors 33 that guide the reflected laser beam to the photodiode array 31, and a light receiving lens 32 that is positioned on an optical path of the reflected beam and focuses the reflected beam on the photodiode array 31. The rotary mirror 10 includes a light projecting mirror 11 that reflects and projects a laser beam emitted by the laser diode module 20 while rotating, and a light receiving mirror 12 that rotates coaxially with the light projecting mirror 11 and guides a reflected laser beam from the object to the photodiode module 30 while rotating. A method of performing scanning by rotating mirrors to project a laser beam and to receive the reflected laser beam is referred to as a rotating mirror system.

When the laser diode module 20 located at the upper part of FIG. 2A emits a laser beam toward the right in FIG. 2A, the laser beam hits the light projecting mirror 11, and the rotary mirror 10 projects the laser beam toward the near side of FIG. 2A (toward the laser radar cover 90). The reflected beam from the near side to the depth side in FIG. 2A hits the light receiving mirror 12 located at the lower part of FIG. 2A, is reflected to the left in FIG. 2A, and is guided to the fixed mirror 33. With reference to FIG. 2B, the laser diode array 21 located at the central part of FIG. 2B emits a laser beam to the right in FIG. 2B. The condenser lens 22 condenses the laser beam, and narrows the divergence angle of the laser beam. Then, the light projecting mirror 11 reflects and projects the laser beam upward in FIG. 2B (toward the laser radar cover 90). With reference to FIG. 2D, the reflected laser beam coming from the upper side in FIG. 2D (from a laser radar cover 90 side) hits the light receiving mirror 12, is reflected toward the fixed mirror 33 located at the right part of FIG. 2D, and then passes through the light receiving lens 32. Then, the other fixed mirror 33 reflects the reflected laser beam and the photodiode module 30 receives the reflected laser beam.

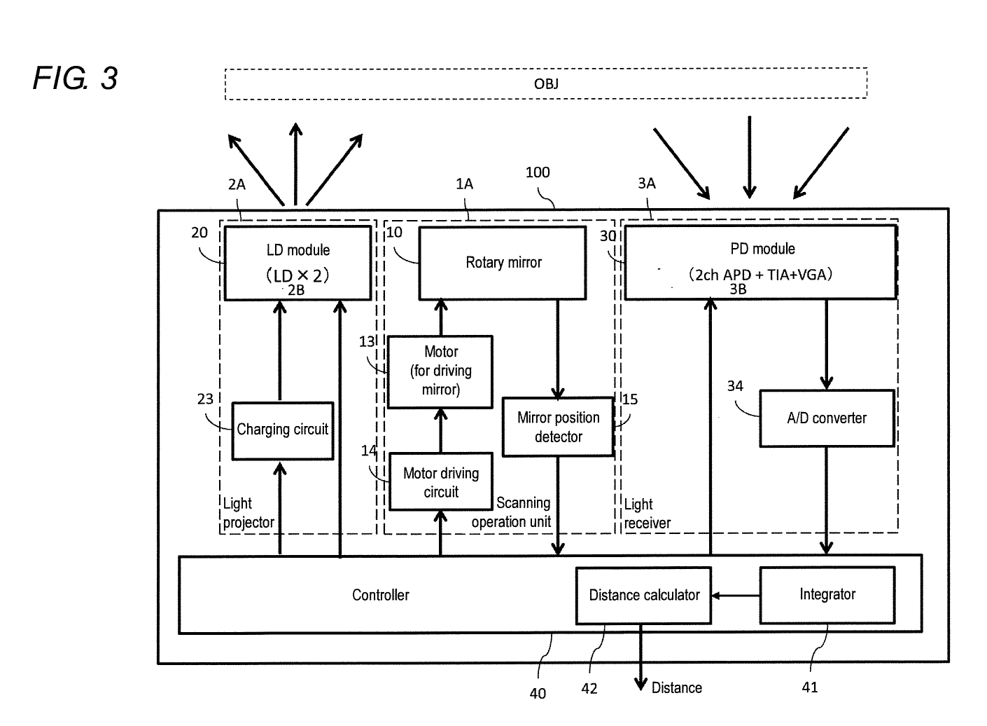

With reference to the block diagram of FIG. 3, the scanning-type distance measuring apparatus 100 will be described in more detail. The scanning-type distance measuring apparatus 100 includes a light projector 2A including the above-described laser diode module (LD module) 20, a light receiver 3A including the photodiode module (PD module) 30, a scanning operation unit 1A including the rotary mirror 10 and the like, and a controller 40 that controls the above constituents and outputs a measured distance to an external mechanism.

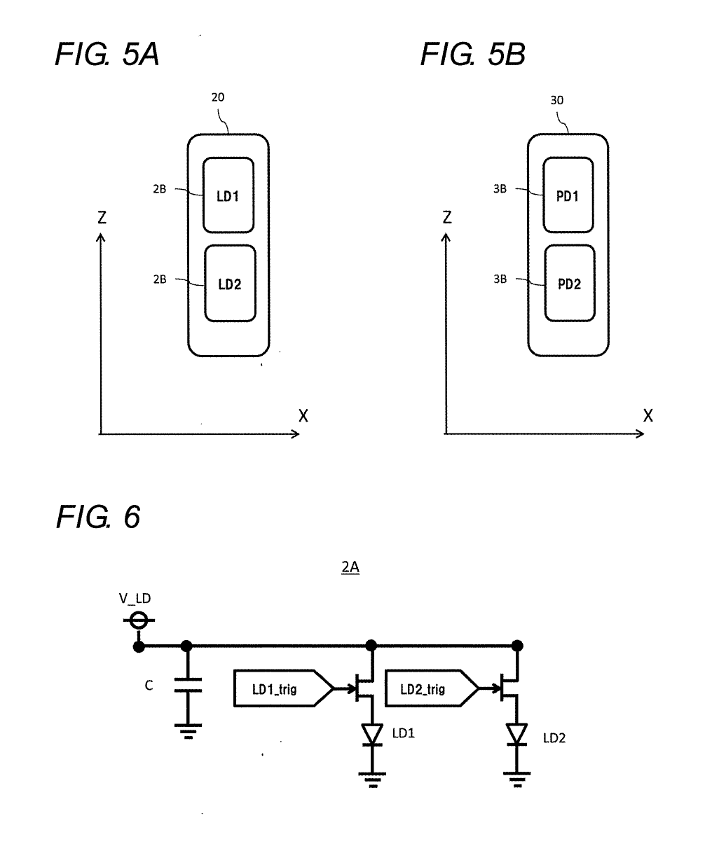

The light projector 2A includes the laser diode module 20 having two laser diodes 2B, which are light projecting elements, and a charging circuit 23. The light projector 2A projects laser beams at predetermined time intervals. As illustrated in FIG. 5A, the two laser diodes 2B are arranged side by side in the vertical direction (Z-axis direction), and are configured to project light beams in the direction vertical to the object OBJ. As illustrated in FIG. 6, the charging circuit 23 includes a capacitor C and FETs. The capacitor C receives power from a power supply V_LD and is charged. Each FET is a switching element disposed between the laser diode 2B and the capacitor C to control power supply from the capacitor C to the laser diode 2B. The controller 40 controls a control signal LD1_trig and a control signal LD2_trig that turn on and off the FETs.

After charging of the capacitor C is completed, the light projector 2A turns on the FET corresponding to one of the two laser diodes 2B to supply power to the laser diode 2B and to project a laser beam. Therefore, the light projector 2A does not cause the two laser diodes 2B to project laser beams simultaneously. When comparing the time during which one laser diode 2B projects a laser beam and a charging time of the capacitor C required for the laser diode 2B to project the laser beam, the latter is longer. Therefore, the light projector 2A projects a laser beam after a predetermined time passes. The relationship between the charging time and a light projection time and the like will be described later.

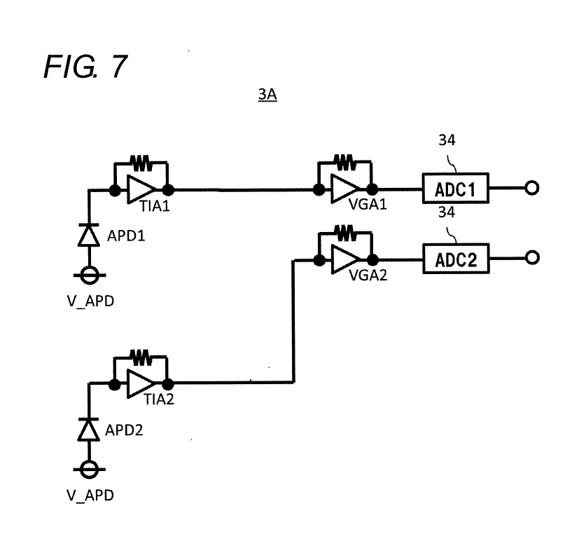

The light receiver 3A includes the photodiode module 30 having two photodiodes 3B, which are light receiving elements, and an A/D converter 34. The light receiver 3A receives a reflected beam of a laser beam projected by the light projector 2A, and outputs the light reception intensity signal of the reflected beam to the controller 40. As illustrated in FIG. 5B, the two photodiodes 3B are arranged side by side in the vertical direction (Z-axis direction), and are configured to receive light beams in the direction vertical to the object OBJ. As illustrated in FIG. 7, the photodiode 3B includes an element such as a photodiode (for example, an avalanche photodiode APD) that converts light energy into electric energy, a transimpedance amplifier TIA that converts current output from the element into a voltage signal, a variable gain amplifier VGA that amplifies the voltage signal, and the like. The A/D converter 34 converts an optical signal that the photodiode 3B receives into a digital signal.

The scanning operation unit 1A includes the rotary mirror 10 driven by the motor 13 to rotate as described above, a motor driving circuit 14 that drives the motor 13 to rotate, and a mirror position detector 15 that detects the position (rotation angle) of the rotary mirror 10. The scanning operation unit 1A operates so as to rotate the rotary mirror 10 in the horizontal direction (direction orthogonal to the direction in which the laser diodes 2B and the photodiodes 3B are arranged), and to perform scanning by projecting and receiving light beams in the horizontal direction. Note that in the embodiment, the scanning operation unit 1A rotates both of the light projecting mirror 11 and the light receiving mirror 12 because the light projecting mirror 11 and the light receiving mirror 12 rotate coaxially. However, as in JP 2004-177350 A and JP 2005-300233 A, a configuration is possible where a rotating mirror is provided only on a light projection side, and a rotating mirror is not provided on a light reception side.

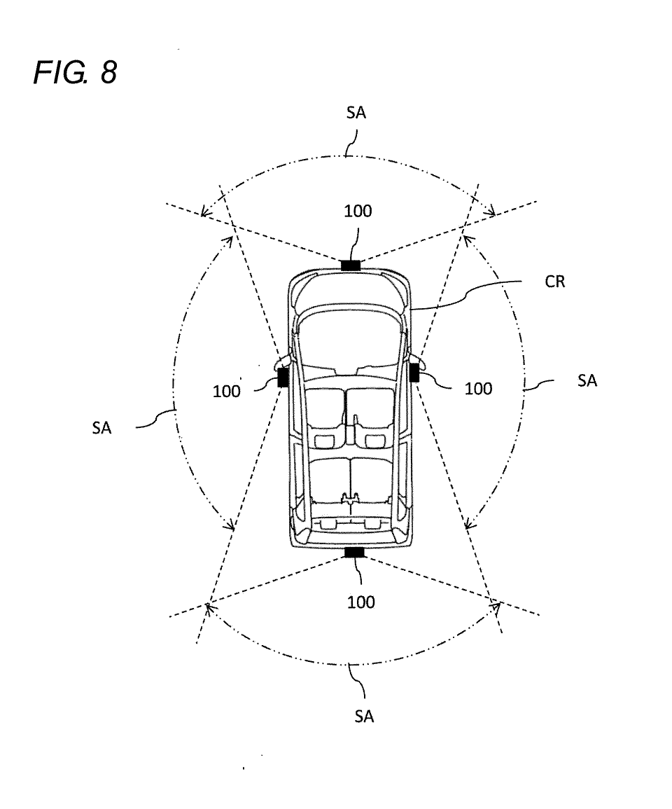

The controller 40 drives the scanning operation unit 1A and detects the mirror position. When the mirror position is in a predetermined mirror position, the controller 40 causes the light projector 2A to project a light beam and reads a signal (light reception intensity signal) from the light receiver 3A that has received the reflected light beam. After the controller 40 reads the signal from the light receiver 3A, the controller 40 repeats light projection and reception while further driving the scanning operation unit 1A to rotate by a predetermined angle per unit time. By repeating the above operation, the scanning-type distance measuring apparatus 100 performs scanning with a predetermined angle of view in the horizontal direction, and measures the distance to the object OBJ within the angle of view. For example, as illustrated in FIG. 8, the scanning-type distance measuring apparatuses 100 are provided at the front, the rear, the right, and the left of a vehicle CR. Each scanning-type distance measuring apparatus 100 has a horizontal angle of view of a scanning range SA (for example, 140 degrees). Therefore, the scanning-type distance measuring apparatuses 100 can measure the distance to the object OBJ located in almost any direction.

The controller 40 includes an integrator 41 and a distance calculator 42. The integrator 41 integrates time-series light reception intensity signals for each photodiode 3B, which is a light receiving element. The light receiver 3A outputs the time-series light reception intensity signals when the light receiver 3A receives reflected beams corresponding to laser beams projected at predetermined time intervals. The distance calculator 42 calculates the distance to the object OBJ for each light receiving element, based on integration that the integrator 41 performs. Note that the controller 40 is a microcomputer which controls a ROM (Read Only Memory) that stores a control program and the like, a RAM (Random Access Memory) that temporarily stores a received signal, data such as the mirror position, and the like, a network adapter for exchanging the above data and program with an external mechanism, power supply monitoring, and the like.

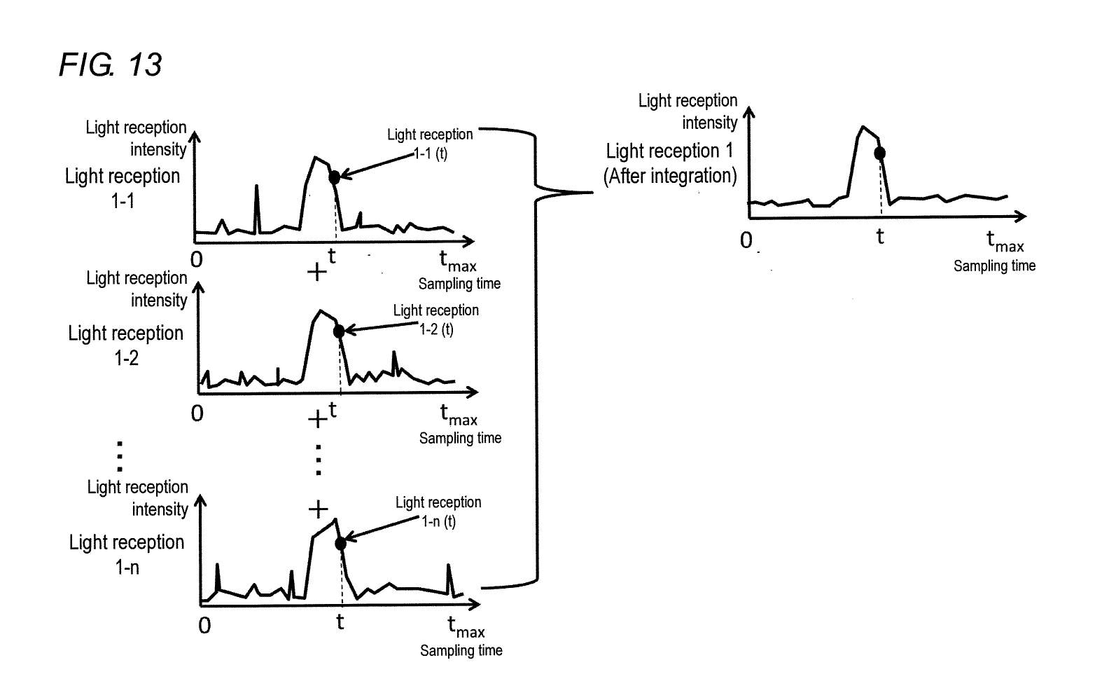

As illustrated in FIG. 13, the integrator 41 obtains the sum of, that is, integrates time-series light reception intensity signals obtained from light reception performed a plurality of times. For example, in the first light projection and reception, a light reception intensity signal “light reception 1-1” illustrated in FIG. 13 is obtained. In the second light projection and reception, a light reception intensity signal “light reception 1-2” is obtained. In the Nth light projection and reception, a light reception intensity signal “light reception 1-n” is obtained. Since random noise is included in the received signals, the first to Nth light reception intensity signals differ from each other. However, by integrating the light reception intensity signals as illustrated in the graph on the right side of FIG. 13 and Formula (1) representing the graph, it is possible to reduce a noise component without reducing a signal component, and to improve sensitivity.

$$\begin{matrix}[ Formula 1 ] & \\ [ \frac{{Σ}_{n } light reception 1 - i ( 0 )}{n} , … , \frac{{Σ}_{n } light reception 1 - i ( t )}{n} , … , \frac{{Σ}_{n } light reception 1 - i ( {t}_{max} )}{n} ] & ( 1 )\end{matrix}$$

Time t illustrated in FIG. 13 indicates a time period taken from light projection to light reception. Therefore, the distance calculator 42 calculates the distance to the object for each light receiving element, based on the time t at which integrated light reception intensity is greatest. For example, assuming that the distance to the measurement target is not greater than 100 meters, tmax is approximately 700 nanoseconds.

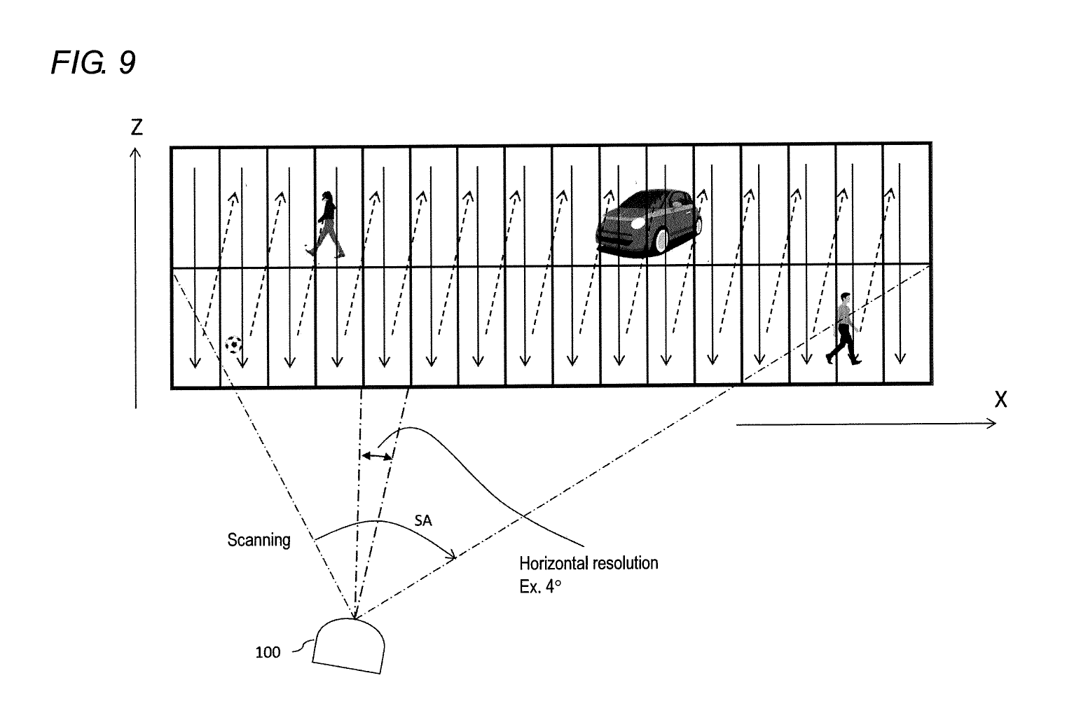

With reference to FIGS. 9 to 12, scanning operation and light projection and reception timings in the scanning-type distance measuring apparatus 100 will be described in detail. FIG. 9 illustrates scanning operation in a case where the scanning-type distance measuring apparatus 100 scans the scanning range SA. In the scanning-type distance measuring apparatus 100, the two laser diodes 2B sequentially project laser beams, and the two photodiodes 3B receive the laser beams. The two laser diodes 2B and the two photodiodes 3B are arranged in the Z-axis direction (vertical direction) as illustrated in FIGS. 5A and 5B. A downward (negative Z-axis direction) solid arrow in FIG. 9 indicates that the upper laser diode 2B from among the two laser diodes 2B emits light first, and then the lower laser diode 2B emits light. This is because the two laser diodes do not emit light simultaneously as described above.

The upper photodiode 3B receives a reflected beam of the laser beam projected by the upper laser diode 2B. The lower photodiode 3B receives a reflected beam of the laser beam projected by the lower laser diode 2B. Therefore, the upper laser diode 2B and the upper photodiode 3B first projects and receives a laser beam, respectively. Then, the lower laser diode 2B and the lower photodiode 3B projects and receives a laser beam, respectively. After the lower laser diode 2B and the lower photodiode 3B projects and receives a laser beam, respectively, the upper laser diode 2B and the upper photodiode 3B projects and receives a laser beam, respectively. Therefore, the scanning direction is diagonally upward to the right as indicated by a dotted arrow. Note that the rotary mirror 10 rotates while the upper laser diode 2B and the upper photodiode 3B projects and receives a laser beam, respectively, and then the lower laser diode 2B and the lower photodiode 3B projects and receives a laser beam, respectively. Therefore, the actual scanning direction is not downward (negative Z-axis direction) as indicated by the solid arrow but strictly speaking, diagonally downward to the right. However, for the sake of simplicity of the drawing, the solid arrow indicates the scanning direction.

The scanning-type distance measuring apparatus 100 is configured such that the rotary mirror 10 causes scanning to be performed toward the right in the horizontal direction (X-axis positive direction) across the scanning range SA while the upper laser diode and photodiode and the lower laser diode and photodiode alternately project and receive a laser beam repeatedly. Therefore, scanning is performed similarly to raster scanning as a whole. More specifically, in the embodiment, the rotary mirror 10 rotates by 0.25 degrees between one performance of light projection and reception and the next performance of light projection and reception. For example, the upper laser diode 2B projects a laser beam, and the upper photodiode 3B receives the laser beam correspondingly. Then, the rotary mirror 10 rotates by 0.25 degrees before the lower laser diode 2B projects a laser beam and the lower photodiode 3B receives the laser beam correspondingly. The rotary mirror 10 further rotates by 0.25 degrees before the upper laser diode 2B again projects a laser beam and the upper photodiode 3B again receives the laser beam correspondingly. Therefore, the rotary mirror rotates by 0.5 degrees from light reception of the upper photodiode 3B to light reception of the next upper photodiode 3B.

FIG. 9 illustrates, as an example, a field of view of the scanning-type distance measuring apparatus 100 where a soccer ball exists in a lower left area, human beings exist in an upper left area and a lower right area, and a car exists in an approximately upper central area.

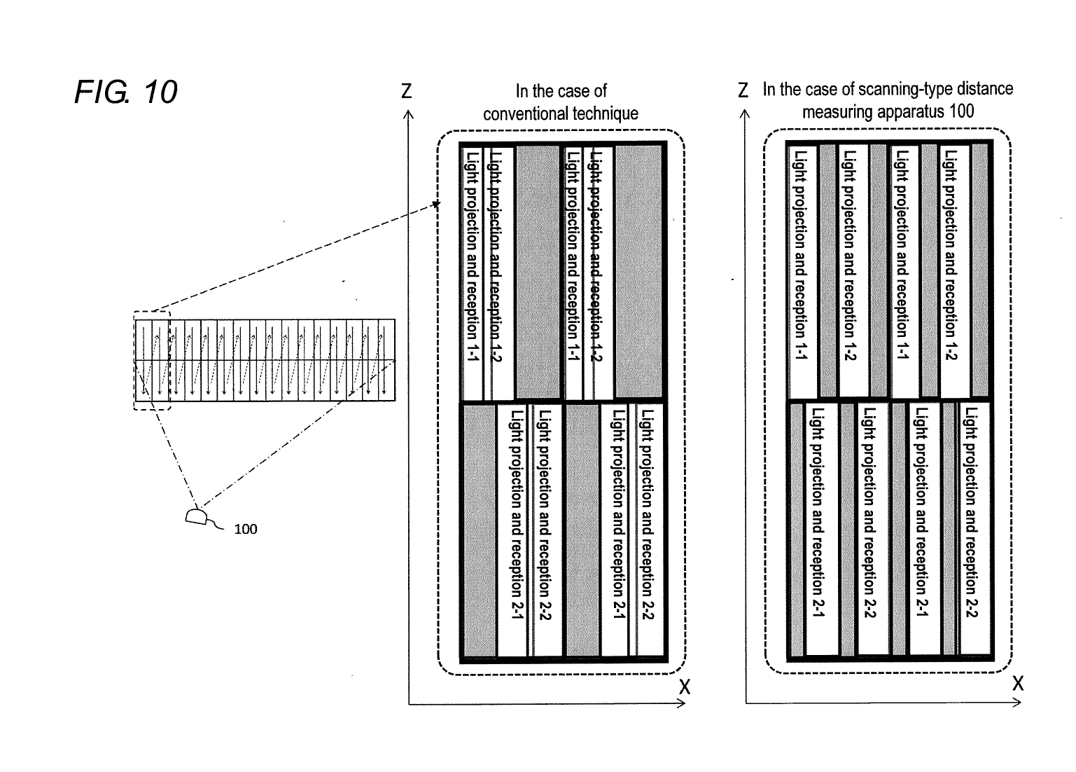

FIG. 10 comparatively illustrates undetected areas in such a field of view, the undetected areas generated in a scanning-type distance measuring apparatus of a conventional technique and generated in the scanning-type distance measuring apparatus 100 according to one or more embodiments of the disclosure. Generally, in a scanning-type distance measuring apparatus, in order to reduce the influence of noise of a received reflected beam and to amplify a light reception intensity signal corresponding to the reflected beam from an object, signals output from a light receiving element are integrated a plurality of times. In the scanning-type distance measuring apparatus of the conventional technique, it is easier to integrate signals corresponding to reflected beams from an identical object and to distinguish the object from noise if an identical light receiving element from among a plurality of light receiving elements continuously outputs signals. Therefore, distance is usually measured based on light reception intensity signals that an identical light receiving element continuously outputs a plurality of times (twice in FIG. 10).

In the scanning-type distance measuring apparatus of the conventional technique, first, an upper laser diode and an upper photodiode continuously perform light projection and reception twice, for example, “light projection and reception 1-1” and “light projection and reception 1-2”. The scanning-type distance measuring apparatus calculates the distance based on the result obtained by integrating light reception intensity signals output in the light projection and reception performed twice. Next, a lower laser diode and a lower photodiode continuously perform light projection and reception twice, for example, “light projection and reception 2-1” and “light projection and reception 2-2”. The scanning-type distance measuring apparatus calculates the distance based on the result obtained by integrating light reception intensity signals output in the light projection and reception performed twice. Then, the upper laser diode and the upper photodiode continuously perform light projection and reception twice, for example, “light projection and reception 1-1” and “light projection and reception 1-2”. The scanning-type distance measuring apparatus calculates the distance based on the result obtained by integrating light reception intensity signals output in the light projection and reception performed twice. In this case, the rotary mirror 10 rotates between the first “light projection and reception 1-2” and the second “light projection and reception 1-1”. Therefore, an area to which a laser beam cannot be projected and from which a laser beam cannot be received (undetected area) is generated. The undetected area is illustrated in gray in the middle diagram of FIG. 10. In addition, in the conventional technique illustrated in FIG. 10, the area of “light projection and reception 1-1” and the area of “light projection and reception 1-2” adjacent to each other partially overlap with each other.

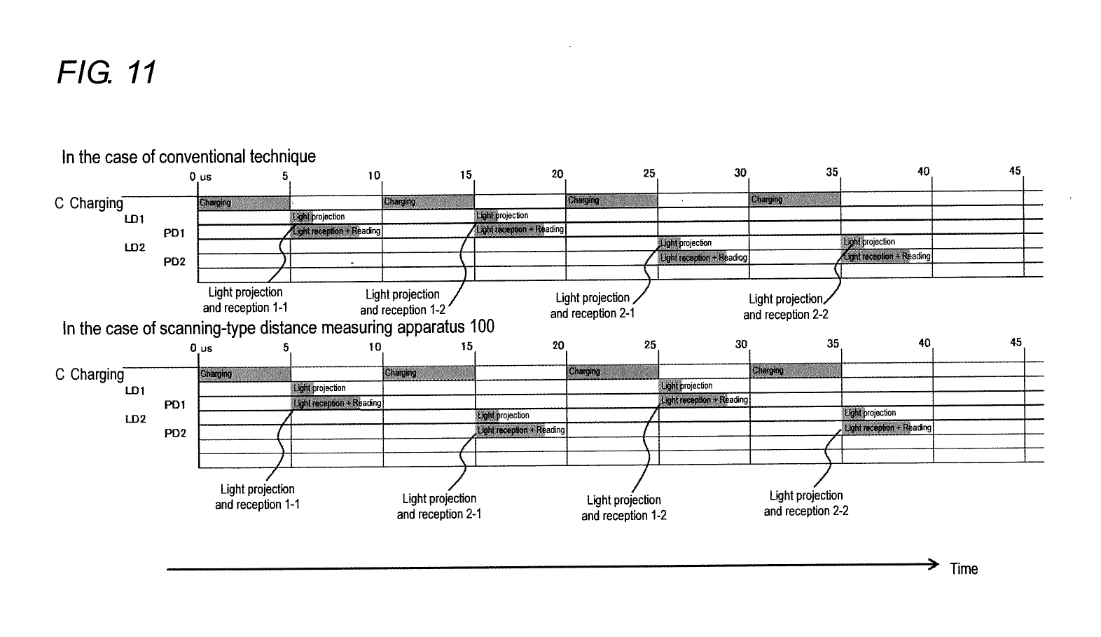

The upper graph in FIG. 11 illustrates charging timings of a capacitor C and light projection and reception timings at that time. FIG. 11 illustrates an example of performing charging and light projection and reception (and signal reading) every 10 μs. First, the capacitor C is charged in a period from 0 to 5 μs. Using the charged power, the upper laser diode (LD1 in FIG. 11) projects a laser beam. Subsequently, the photodiode (PD1 in FIG. 11) receives the laser beam. The above light projection, light reception, and signal reading are performed in a period from 5 to 10 μs (“light projection and reception 1-1”). Then, the capacitor C is charged in a period from 10 to 15 μs. Using the charged power, the identical upper laser diode (LD1 in FIG. 11) projects a laser beam. Subsequently, the photodiode (PD1 in FIG. 11) receives the laser beam. The above light projection, light reception, and signal reading are performed in a period from 15 to 20 μs (“light projection and reception 1-2”). That is, in the case of the scanning-type distance measuring apparatus of the conventional technique, the identical upper (or lower) laser diode and photodiode continuously perform light projection and reception twice. Therefore, regarding signals obtained by light reception, signals from the identical light receiving element are continuously integrated.

In the scanning-type distance measuring apparatus 100 according to one or more embodiments of the disclosure, as illustrated in the right diagram in FIG. 10, first, the upper laser diode 2B and the upper photodiode 3B perform light projection and reception once, for example, “light projection and reception 1-1”. Then, the lower laser diode 2B and the lower photodiode 3B perform light projection and reception once, for example, “light projection and reception 2-1”. Then, the upper laser diode 2B and the upper photodiode 3B perform light projection and reception once, for example, “light projection and reception 1-2”. The scanning-type distance measuring apparatus 100 calculates the distance, based on the result obtained by integrating light reception intensity signals output in the light projection and reception performed twice, that is, “light projection and reception 1-1” and “light projection and reception 1-2”. Next, the lower laser diode 2B and the lower photodiode 3B perform light projection and reception once, for example, “light projection and reception 2-2”. The scanning-type distance measuring apparatus 100 calculates the distance, based on the result obtained by integrating the light reception intensity signals output in the light projection and reception performed twice, that is, “light projection and reception 2-1” and “light projection and reception 2-2”. In this case, the rotary mirror 10 rotates between “light projection and reception 1-1” and “light projection and reception 1-2” and between “light projection and reception 2-1” and “light projection and reception 2-2”. Therefore, similarly to the scanning-type distance measuring apparatus of the conventional technique, an area to which a laser beam cannot be projected and from which the laser beam cannot be received (undetected area) illustrated in gray is generated.

Charging timings of the capacitor C and light projection and reception timings at that time are as follows. As illustrated in FIG. 11, first, the capacitor C is charged in a period from 0 to 5 μs. Using the charged power, the upper laser diode 2B (LD1 in FIG. 11) projects a laser beam. Subsequently, the photodiode 3B (PD1 in FIG. 11) receives the laser beam. Following this light reception, the controller 40 reads a light reception intensity signal from the photodiode 3B. The above light projection, light reception, and signal reading are performed in a period from 5 to 10 μs (“light projection and reception 1-1”). The integrator 41 integrates the light reception intensity signal with a light reception intensity signal obtained from the upper photodiode 3B before. Then, the capacitor C is charged in a period from 10 to 15 μs. Using the charged power, the lower laser diode 2B (LD2 in FIG. 11) projects a laser beam. Subsequently, the photodiode 3B (PD2 in FIG. 11) receives the laser beam. This light projection and reception is performed in a time period from 15 to 20 μs (“light projection and reception 2-1”). Following this light reception, the controller 40 reads a light reception intensity signal from the photodiode 3B. The above light projection, light reception, and signal reading are performed in the period from 15 to 20 μs (“light projection and reception 2-1”). The integrator 41 integrates the light reception intensity signal with a light reception intensity signal obtained from the lower photodiode 3B before.

That is, in the case of the scanning-type distance measuring apparatus 100 according to one or more embodiments of the disclosure, the upper laser diode 2B and photodiode 3B and the lower laser diode 2B and photodiode 3B alternately project and receive a laser beam, and light reception intensity signals obtained from the photodiodes 3B are integrated for each photodiode 3B. In this case, the integrator 41 alternately integrates light reception intensity signals obtained from the upper photodiode 3B and light reception intensity signals obtained from the lower photodiode 3B.

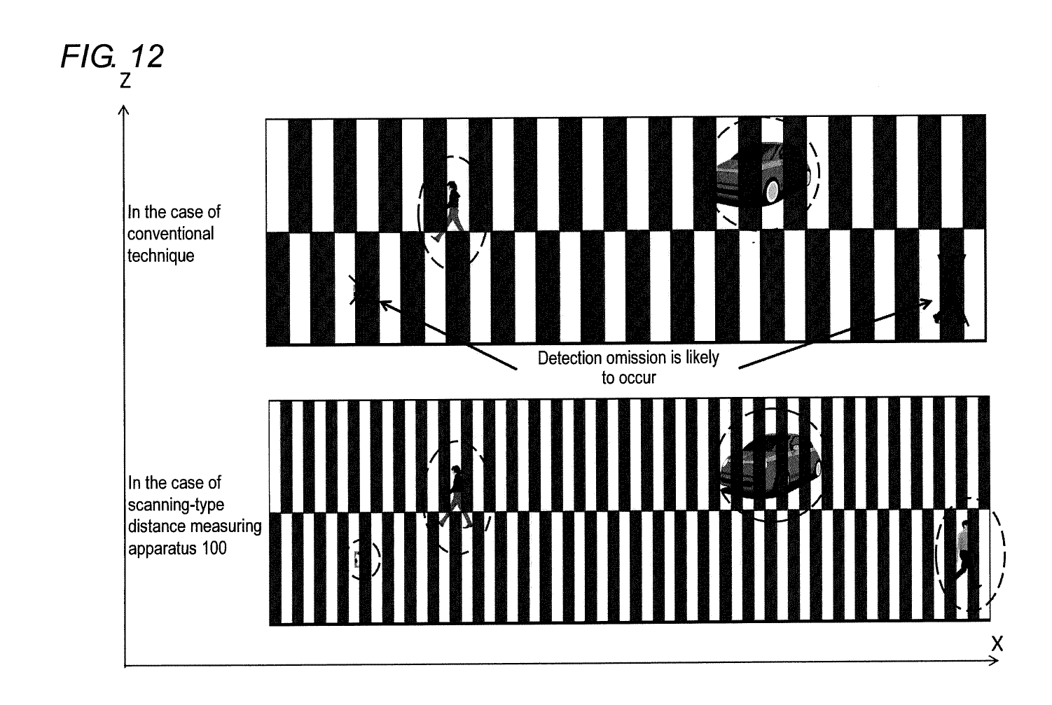

An undetected area is also generated in the scanning-type distance measuring apparatus 100 according to one or more embodiments of the disclosure. However, the size of each undetected area in the scanning-type distance measuring apparatus 100 is smaller than the size of each undetected area in the scanning-type distance measuring apparatus of the conventional technique. As illustrated in FIG. 12, the size difference in each undetected area prevents detection omission of a relatively small object. Note that a black masked portion in FIG. 12 indicates an undetected area. It rarely happens that the scanning-type distance measuring apparatus of the conventional technique does not detect a car, which is a relatively large object, even if each undetected area is large. However, if the size of an object is approximately identical to the size of a human being, the scanning-type distance measuring apparatus of the conventional technique may detect the object (human being on the upper stage) or may not detect the object (human being on the lower stage). Furthermore, it is estimated that the scanning-type distance measuring apparatus of the conventional technique is less likely to detect the soccer ball, which is smaller. In contrast, the scanning-type distance measuring apparatus 100 is more likely to detect even a soccer ball, because each undetected area is smaller.

As described above, the integrator 41 of the scanning-type distance measuring apparatus 100 integrates a light reception intensity signal output from the photodiode 3B which is one light-receiving element, and then integrates a light reception intensity signal output from the photodiode 3B which is another light receiving element. Thus, an identical light receiving element does not continuously output light reception intensity signals, resulting in reduction in time taken to acquire output signals from another light receiving element. Accordingly, it is possible to provide a scanning-type distance measuring apparatus 100 that enables reduction in the undetected area generated in each output from each light receiving element and makes detection omission less likely to occur.

### Second Embodiment

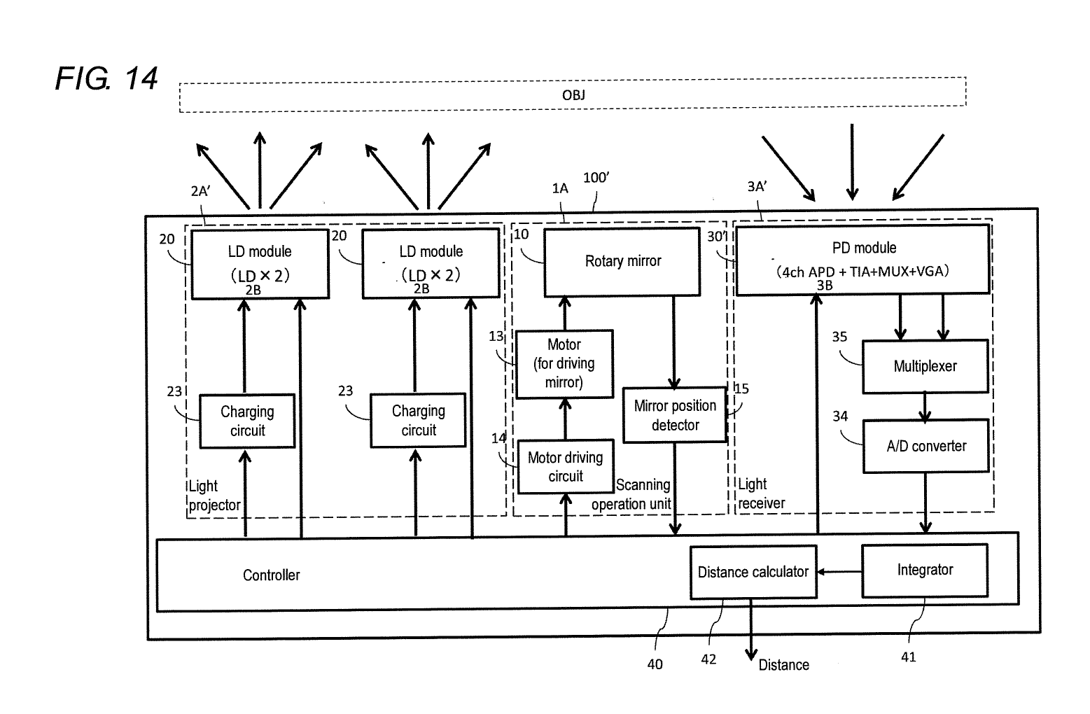

A scanning-type distance measuring apparatus 100′ according to one or more embodiments will be described with reference to FIGS. 14 to 20. Note that in order to omit description overlapping with the description in an illustrative embodiment, identical reference signs are given to identical constituents, and point of difference will be mainly described. The scanning-type distance measuring apparatus 100′ includes a light projector 2A′ including two laser diode modules 20, a light receiver 3A′ including a photodiode module 30′, a scanning operation unit 1A including a rotary mirror 10 and the like, and a controller 40 that controls the above constituents and outputs a measured distance to an external mechanism.

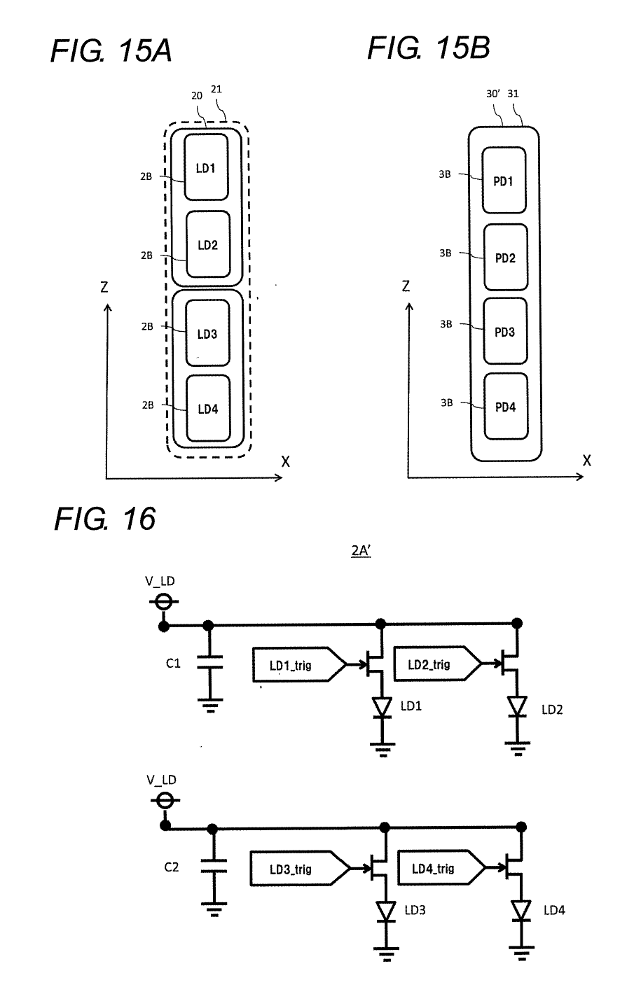

The light projector 2A′ includes a laser diode array 21 (light projecting element array) including two light projectors 2A. Each light projector 2A includes a laser diode module 20 having two laser diodes 2B, and a charging circuit 23. The light projector 2A′ projects laser beams at predetermined time intervals. As illustrated in FIG. 15A, in the light projector 2A′, the laser diode modules 20 which each include the two laser diodes 2B arranged in the vertical direction (Z-axis direction) are arranged in the vertical direction. That is, four laser diodes 2B in total are arranged in the light projector 2A′. The light projector 2A′ is configured to project a laser beam in the height direction of an object OBJ. As illustrated in FIG. 16, a charging circuit 23 is provided in each light projector 2A in the same manner as in the charging circuit 23 illustrated in FIG. 6. The controller 40 controls a control signal LD1_trig, a control signal LD2_trig, a control signal LD3_trig, and a control signal LD4_trig for turning on and off respective FETs.

In the light projector 2A′, one charging circuit 23 is provided for each laser diode module 20. Therefore, although the two laser diodes 2B in one laser diode module 20 do not project laser beams simultaneously, two laser diodes 2B in the two laser diode modules 20 can project laser beams simultaneously.

The light receiver 3A′ includes a photodiode module 30′ having four photodiodes 3B, and an A/D converter 34. The light receiver 3A′ receives a reflected beam of a laser beam projected by the light projector 2A′, and outputs a light reception intensity signal of the reflected beam to the controller 40. As illustrated in FIG. 15B, the four photodiodes 3B are arranged side by side in the vertical direction (Z-axis direction) to form a photodiode array 31 (light receiving element array), and are configured to receive a laser beam in the height direction of the object OBJ. In the photodiode array 31, the plurality of photodiodes 3B is arranged in a row in the direction identical to the direction in which the plurality of laser diodes 2B of the laser diode array 21 is arranged.

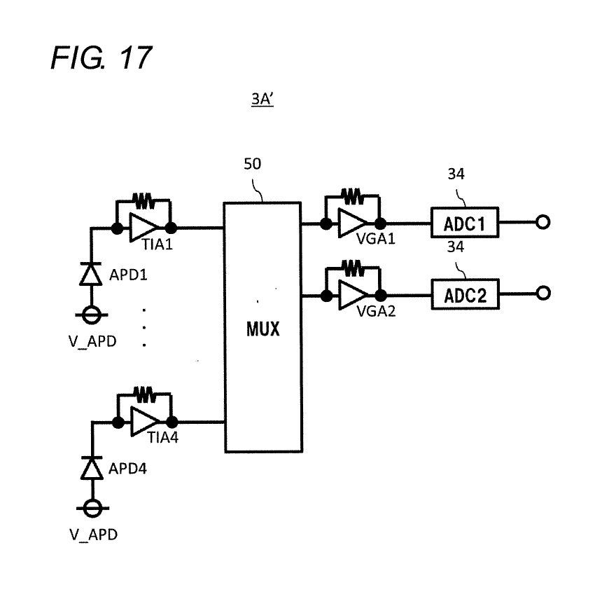

As illustrated in FIG. 17, the photodiode 3B includes an element such as a photodiode (for example, an avalanche photodiode APD) that converts light energy into electric energy, a transimpedance amplifier TIA that converts current output from the element into a voltage signal, a multiplexer 35 that selects an output of a voltage signal from one photodiode 3B from among outputs of voltage signals from the four photodiodes 3B, a variable gain amplifier VGA that amplifies the selected voltage signal, and the like.

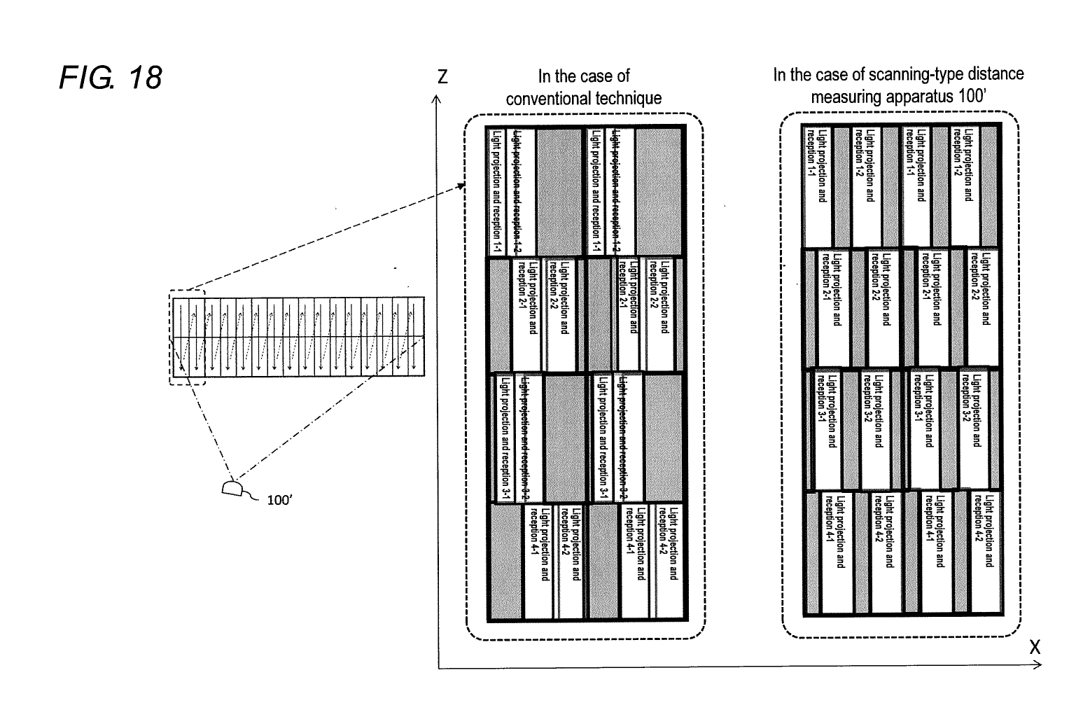

With reference to FIGS. 18 to 20, scanning operation and light projection and reception timings in the scanning-type distance measuring apparatus 100′ will be described in detail. FIG. 18 comparatively illustrates undetected areas in a scanning range SA similar to that in FIG. 9, the undetected areas generated in a scanning-type distance measuring apparatus of a conventional technique and generated in the scanning-type distance measuring apparatus 100′ according to one or more embodiments of the disclosure.

In the scanning-type distance measuring apparatus of the conventional technique, first, an uppermost laser diode and an uppermost photodiode continuously perform light projection and reception twice, for example, “light projection and reception 1-1” and “light projection and reception 1-2”. The scanning-type distance measuring apparatus calculates the distance, based on the result obtained by integrating light reception intensity signals output in the light projection and reception performed twice. A lower-middle laser diode and a lower-middle photodiode continuously perform light projection and reception twice, for example, “light projection and reception 3-1” before “light projection and reception 1-2” and “light projection and reception 3-2” after “light projection and reception 1-2”. The scanning-type distance measuring apparatus calculates the distance, based on the result obtained by integrating light reception intensity signals output in the light projection and reception performed twice. Then, an upper-middle laser diode and an upper-middle photodiode continuously perform light projection and reception twice, for example, “light projection and reception 2-1” and “light projection and reception 2-2”. The scanning-type distance measuring apparatus calculates the distance, based on the result obtained by integrating light reception intensity signals output in the light projection and reception performed twice. A lowermost laser diode and a lowermost photodiode continuously perform light projection and reception twice, for example, “light projection and reception 4-1” before “light projection and reception 2-2” and “light projection and reception 4-2” after “light projection and reception 2-2”. The scanning-type distance measuring apparatus calculates the distance, based on the result obtained by integrating light reception intensity signals output in the light projection and reception performed twice. Then, the uppermost laser diode and the uppermost photodiode continuously perform light projection and reception twice, for example, “light projection and reception 1-1” and “light projection and reception 1-2”. The scanning-type distance measuring apparatus calculates the distance, based on the result obtained by integrating light reception intensity signals output in the light projection and reception performed twice. In this case, a rotary mirror 10 rotates between the first “light projection and reception 1-2” and the second “light projection and reception 1-1”. Therefore, an area to which a laser beam cannot be projected and from which the laser beam cannot be received (undetected area) illustrated in gray is generated. Similarly, an undetected area is generated in the laser diode and the photodiode on each of the other stages.

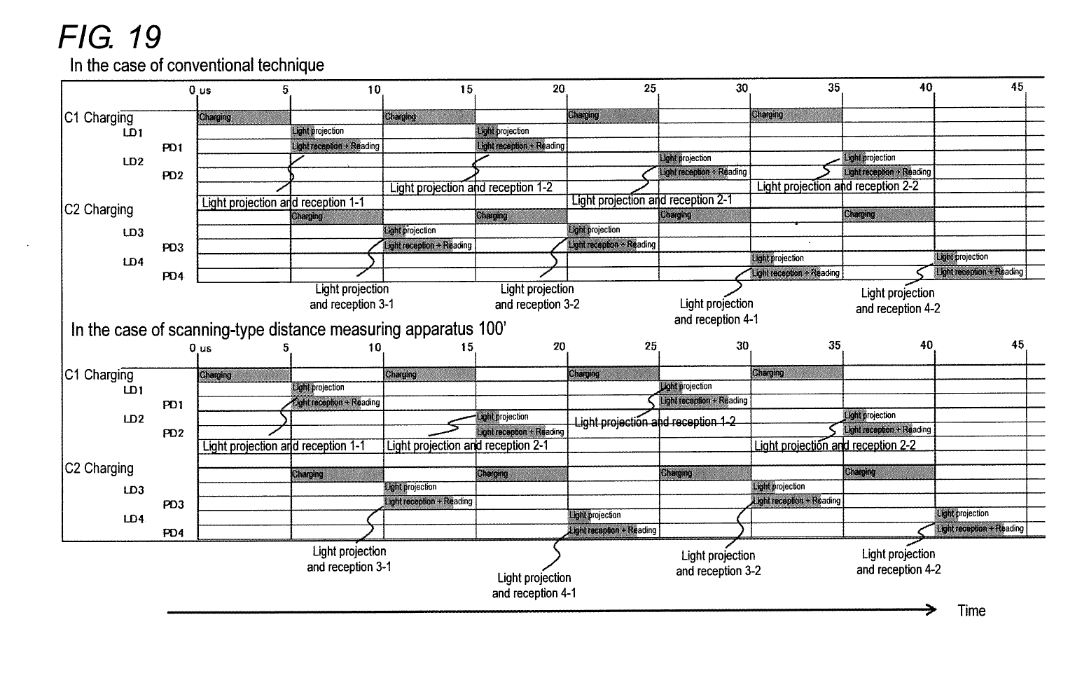

FIG. 19 illustrates charging timings of capacitors C1 and C2 and light projection and reception timings at that time. In FIG. 19, first, the capacitor C1 is charged in a period from 0 to 5 μs. Using the charged power, the uppermost laser diode (LD1 in FIG. 19) projects a laser beam. Subsequently, the photodiode (PD1 in FIG. 19) receives the laser beam. The above light projection and light reception are performed in a period from 5 to 10 μs (“light projection and reception 1-1”). In addition, the capacitor C2 is charged in the period from 5 to 10 μs. Using the charged power, the lower-middle laser diode (LD3 in FIG. 19) projects a laser beam. Subsequently, the photodiode (PD3 in FIG. 19) receives the laser beam. The above light projection and light reception are performed in a period from 10 to 15 μs (“light projection and reception 3-1”).

Then, the capacitor C1 is charged in the period from 10 to 15 μs. Using the charged power, the identical uppermost laser diode (LD1 in FIG. 19) projects a laser beam. Subsequently, the photodiode (PD1 in FIG. 11) receives the laser beam. The above light projection and light reception are performed in the period from 10 to 15 μs (“light projection and reception 1-2”). In addition, the capacitor C2 is charged in the period from 15 to 20 μs. Using the charged power, the lower-middle laser diode (LD3 in FIG. 19) projects a laser beam. Subsequently, the photodiode (PD3 in FIG. 19) receives the laser beam. The above light projection and light reception are performed in a period from 20 to 25 μs (“light projection and reception 3-2”).

Then, the capacitor C1 is charged in the period from 20 to 25 μs. Using the charged power, the upper-middle laser diode (LD2 in FIG. 19) projects a laser beam. Subsequently, the photodiode (PD2 in FIG. 19) receives the laser beam. The above light projection and light reception are performed in a period from 25 to 30 μs (“light projection and reception 2-1”). In addition, the capacitor C2 is charged in the period from 25 to 30 μs. Using the charged power, the lowermost laser diode (LD4 in FIG. 19) projects a laser beam. Subsequently, the photodiode (PD4 in FIG. 19) receives the laser beam. The above light projection and light reception are performed in a period from 30 to 35 μs (“light projection and reception 4-1”). That is, in the case of the scanning-type distance measuring apparatus of the conventional technique, the laser diode and photodiode on an identical stage continuously perform light projection and reception twice. Therefore, the multiplexer 35 also continuously selects signals from an identical light receiving element. Therefore, the signals from the identical light receiving element are continuously integrated. In addition, the light projector 2A may cause the light projecting element to project a laser beam which projects a laser beam reflected and received by the light receiving element selected by the multiplexer 35.

In the scanning-type distance measuring apparatus 100′ according to one or more embodiments of the disclosure, as illustrated in FIGS. 18 and 19, first, the uppermost laser diode 2B and the uppermost photodiode 3B perform light projection and reception once, for example, “light projection and reception 1-1”. The capacitor C2 is charged while the uppermost laser diode 2B and the uppermost photodiode 3B perform “light projection and reception 1-1”. When charging of the capacitor C2 is completed, the lower-middle laser diode 2B and the lower-middle photodiode 3B perform “light projection and reception 3-1” once. The capacitor C1 is charged while the lower-middle laser diode 2B and the lower-middle photodiode 3B perform “light projection and reception 3-1”. When charging of the capacitor C1 is completed, the upper-middle laser diode 2B and the upper-middle photodiode 3B perform “light projection and reception 2-1” once. The capacitor C2 is charged while the upper-middle laser diode 2B and the upper-middle photodiode 3B perform “light projection and reception 2-1”. When charging of the capacitor C2 is completed, the lowermost laser diode 2B and the lowermost photodiode 3B perform “light projection and reception 4-1”. The capacitor C1 is charged while the lowermost laser diode 2B and the lowermost photodiode 3B perform “light projection and reception 4-1”.

When charging of the capacitor C1 is completed, the uppermost laser diode 2B and the uppermost photodiode 3B perform light projection and reception once, for example, “light projection and reception 1-2”. The scanning-type distance measuring apparatus 100′ calculates the distance, based on the result obtained by integrating light reception intensity signals output in the light projection and reception performed twice, that is, “light projection and reception 1-1” and “light projection and reception 1-2”. Similarly, the lower-middle laser diode 2B and the lower-middle photodiode 3B perform “light projection and reception 3-2” once. The scanning-type distance measuring apparatus 100′ calculates the distance, based on the result obtained by integrating light reception intensity signals output in the light projection and reception performed twice, that is, “light projection and reception 3-1” and “light projection and reception 3-2”. Similarly to an illustrative embodiment, the rotary mirror 10 rotates, for example, between “light projection and reception 1-1” and “light projection and reception 1-2” and between “light projection and reception 3-1” and “light projection and reception 3-2”. Therefore, similarly to the scanning-type distance measuring apparatus of the conventional technique, an area to which a laser beam cannot be projected and from which the laser beam cannot be received (undetected area) illustrated in gray is generated.

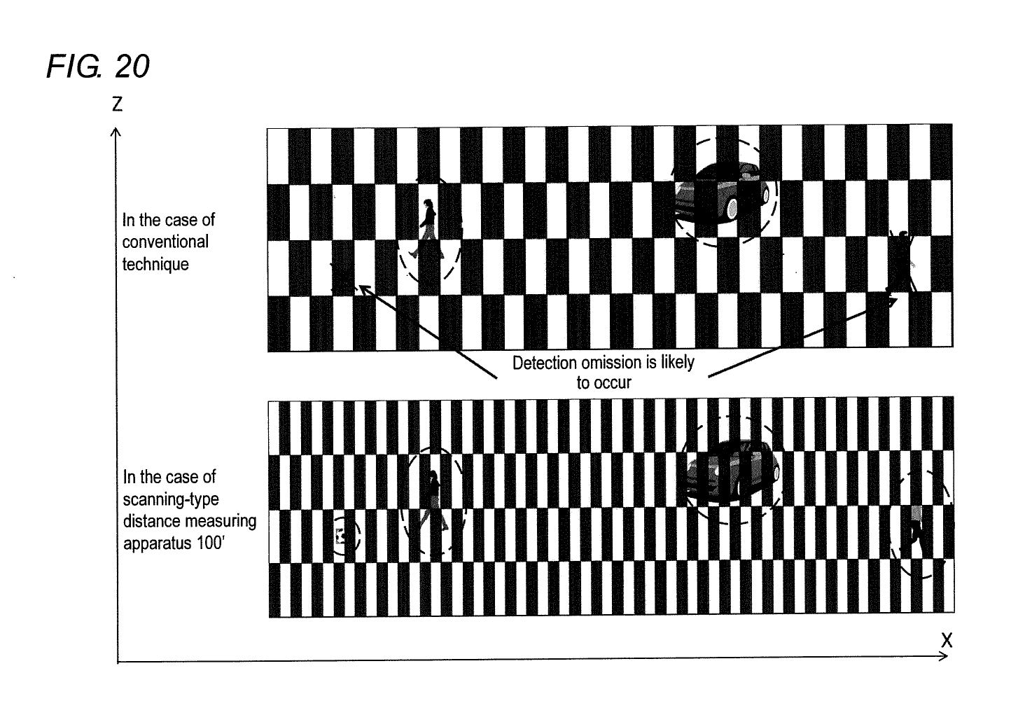

An undetected area is also generated in the scanning-type distance measuring apparatus 100′ according to one or more embodiments of the disclosure. However, the size of each undetected area in the scanning-type distance measuring apparatus 100′ is smaller than the size of each undetected area in the scanning-type distance measuring apparatus of the conventional technique. As illustrated in FIG. 20, the size difference in each undetected area prevents detection omission of a relatively small object. It rarely happens that the scanning-type distance measuring apparatus of the conventional technique does not detect a car, which is a relatively large object, even if each undetected area is large. However, if the size of an object is approximately identical to the size of a human being, the scanning-type distance measuring apparatus of the conventional technique may detect the object (human being on the upper-middle stage) or may not detect the object (human being on the lower-middle stage). Furthermore, the scanning-type distance measuring apparatus of the conventional technique is less likely to detect a soccer ball, which is smaller. In contrast, the scanning-type distance measuring apparatus 100′ is more likely to detect even a soccer ball, because each undetected area is smaller.

As described above, the multiplexer 35 of the scanning-type distance measuring apparatus 100′ selects an output from one light receiving element and then selects an output from another light receiving element. According to the above scanning-type distance measuring apparatus, it is possible to easily switch an output from one light receiving element to an output from another light receiving element. In addition, an integrator 41 of the scanning-type distance measuring apparatus 100′ integrates a light reception intensity signal output from the photodiode 3B which is one light receiving element, and then integrates a light reception intensity signal output from the photodiode 3B which is another light receiving element. Thus, an identical light receiving element does not continuously output light reception intensity signals, resulting in reduction in time taken to acquire output signals from another light receiving element. Accordingly, it is possible to reduce the undetected area generated in each output from each light receiving element and to make detection omission less likely to occur.

Furthermore, the light projector 2A may include a light projecting element array 21 including a plurality of light projecting elements 2B arranged in a row. The light receiver 3A may include a light receiving element array 31 including a plurality of light receiving elements 3B arranged in a row in a direction identical to a direction in which the plurality of light projecting elements 2B of the light projecting element array 21 is arranged. The multiplexer 35 may select one light receiving element 3B from the light receiving element array 31. The light projector 2A may cause the light projecting element 2B to project a laser beam which projects a laser beam reflected and received by the light receiving element 3B selected by the multiplexer 35. Thus, the one-dimensional light projector 2A and the one-dimensional light receiver 3A can measure a distance in a two-dimensional area by performing scanning once.

Note that the disclosure is not limited to the embodiments described as examples, and can be implemented in a configuration within the scope not departing from the contents described in the respective claims. While the disclosure has been particularly illustrated and described mainly with reference to particular embodiments, those skilled in the art can make various changes in quantity and another detailed configuration to the above embodiments without departing from the technical ideas and the scope of the disclosure.

1. A scanning-type distance measuring apparatus comprising:
a light projector configured to project laser beams at predetermined intervals;
a light receiver including a plurality of light receiving elements, the light receiver configured to receive a reflected beam of a laser beam that the light projector projects and configured to output a light reception intensity signal of the reflected beam;
a scanning operation unit configured to at least project a laser beam projected by the light projector to perform scanning;
an integrator configured to integrate, for each light receiving element, time-series light reception intensity signals output by the light receiver when the light receiver receives reflected beams corresponding to the laser beams projected at the predetermined intervals; and
a distance calculator configured to calculate a distance to an object for each light receiving element, based on integration that the integrator performs,
wherein the integrator integrates one light reception intensity signal output from one of the plurality of light receiving elements and then integrates one light reception intensity signal output from another of the plurality of light receiving elements.

2. The scanning-type distance measuring apparatus according to claim 1 further comprising a multiplexer configured to select an output from one of the plurality of light receiving elements from among outputs from the plurality of light receiving elements,
wherein the multiplexer selects an output from one of the plurality of light receiving elements and then selects an output from another of the plurality of light receiving elements.

3. The scanning-type distance measuring apparatus according to claim 2,
wherein the light projector includes a light projecting element array including a plurality of light projecting elements arranged in a row,
wherein the light receiver includes a light receiving element array including the plurality of light receiving elements arranged in a row in a direction identical to a direction in which the plurality of light projecting elements of the light projecting element array is arranged,
wherein the scanning operation unit causes the light projector and the light receiver to perform scanning in a direction orthogonal to the direction in which the plurality of light projecting elements is arranged in the light projecting element array and orthogonal to the direction in which the plurality of light receiving elements is arranged in the light receiving element array,
wherein the multiplexer selects one of the plurality of light receiving elements from the light receiving element array, and
wherein the light projector causes one of the plurality of light projecting elements to project a laser beam, the one of the plurality of light projecting elements projecting a laser beam reflected and received by one of the plurality of light receiving elements selected by the multiplexer.
